(19) United States
(12) Patent Application Publication
(10) Pub. No.: US 2019/0168945 A1
(43) Pub. Date: Jun. 6, 2019

(54) PACKAGING

(71) Applicant: Florian BACHMAIR, Bonn (DE)

(72) Inventor: Florian BACHMAIR, Bonn (DE)

(21) Appl. No.: 16/324,409

(22) PCT Filed: Aug. 9, 2017
(86) PCT No.: PCT/EP2017/070213

§ 371 Date: Feb. 8, 2019

(30) Foreign Application Priority Data
Aug. 9, 2016 (DE) 10 2016 214 793.5

(51) Int. Cl. B65D 81/34; B65D 81/32; A61J 9/02

(52) U.S. Cl. CPC B65D 81/3484; A47J 36/28; A61J 9/02; B65D 81/3266

(57) ABSTRACT

The invention relates to a packaging 1 having a plurality of material-tight separated chambers 2, 3, wherein the chambers 2, 3 contain different substances, and having at least one predetermined breaking point 4 that is formed between two adjacent chambers 2, 3 such that a break in the predetermined breaking point 4 enables a material exchange of the substances of chambers 2, 3 adjacent to the predetermined breaking point 4, wherein the packaging 1 further has a thermocouple 6 capable of being activated that causes an energy flow from or into at least one of the chambers in an activated state.

The invention relates to a packaging having a plurality of material-tight chambers containing different substances, in particular for separately stocking up solid and liquid food ingredients. Further, the packaging has at least one predetermined breaking point that is formed between two adjacent chambers such that a break in the predetermined breaking point enables a material exchange between the chambers adjacent to the predetermined breaking point.

Stocking up individual recipe ingredients in a common packaging is already an integral part of the food industry and also in technical fields of application. The underlying idea is that the consumer is not given the finished product, but all or some of the recipe ingredients that are needed to prepare the product. Typically, these are stocked up at already predetermined mixing ratios in a common packaging and only have to be combined as soon as the consumer needs the product. This is particularly useful for applications that can only be stored for a limited time as a finished product, for example food, adhesives, drugs, and chemical reagents in general.

However, in addition to blending individual recipe ingredients there is often the need to administer the finished product at a defined temperature.

Thus, it is desirable to provide a packaging, which allows preparing a finished product of individual recipe ingredients with minimum effort at a desired temperature.

The problem is solved with a packaging according to claim 1. Advantageous developments are given in the sub-claims.

Thus, according to the invention there is provided a packaging having a plurality of chambers that are separated from each other in a material-tight manner. According to invention the chambers each contain different substances. The packaging has at least one predetermined breaking point that is formed between one and a further chamber such that a break in the predetermined breaking point enables a material exchange of the substances of chambers adjacent to the predetermined breaking point. Further, the packaging has a thermocouple that causes an energy flow from or into at least one of the chambers in an activated state.

In this context, the material separation substantially relates to such substances that are stocked up in the chambers. The term “predetermined breaking point” is meant to be any separation wall, separation zone, or separation membrane that is configured such that no material transport is enabled under normal conditions, for example during storage and transport of the packaging, but this can be caused by a specific application of force to the packaging.

The term “thermocouple” is generally meant to be an energy source or energy depression. The crucial thing is that the thermocouple is suitable to generate a heat input or a heat output from at least one chamber of the packaging.

Thus, the packaging is advantageous for applications in which several materials have to be combined and in which the product obtained from the combination additionally is to be cooled or heated before it is taken out of the packaging. The advantage results from the fact that the essential required components are already present in the packaging whereby storage, transport, and formulation of the desired mixture are significantly simplified. It is also advantageous that the substances present in the individual chambers are already present in the correct amount ratios whereby the risk of a mis-formulation is significantly reduced.

By the presence of the predetermined breaking point it can also be avoided that parts of the recipe are lost before the combination, e.g. by negligence and therefore that the mixture has a false composition. Rather, the individual materials are combined exactly in the given amount ratio.

In a further development the chambers of the packaging are substantially formed of a continuous film. This is advantageous in that the expense of production is low. Preferably, for that a film is folded and tightly sealed at the edges of the packaging whereby first a pouch is formed. The individual chambers of the packaging result for example by specific adhering the pouch layers along defined lines. A film in the meaning of the invention is meant to be for example a plastic film or a laminated material, for example laminated paper.

Suitably the predetermined breaking point consists of two film layers that detachably adhere to each other. This is of advantage in that an increased fluid pressure in a pressurized chamber detaches the detachable connection and so enables a fluid connection between the chambers adjacent to the predetermined breaking point. Also, such a predetermined breaking point can simply be made by pressing two superimposed film layers under the influence of pressure and/or temperature onto each other. In this context, the term “detachable” refers to a reasonable, haptic generatable action of force to one or more chambers of the packaging that causes a detachment of both film layers from each other.

Preferably, the film used is transparent at least in sections. This is of advantage in that the state of the substances in the chambers can visually be inspected. In particular, it is possible to visually inspect the progress of blending at any time during mixing several substances.

In a further development, the thermocouple provides a heat-conducting surface that contacts the generated mixture. The heat-conducting surface is to ensure that the heat transport is effective beyond the system's limit of the thermocouple. As a result that way dissipated heat flows are reduced whereby the thermocouple can be made smaller with the same result. For example, the heat-conducting surface can be made of a metal and/or have a surface texture for increasing the total surface area. Here, a reference is the heat transfer that is established between the mixture and the remaining wall structure of the packaging.

In the meaning of the invention the packaging can have a first chamber containing a solid and a second chamber containing a liquid. Here, the predetermined breaking point is formed between the first chamber and the second chamber. By separately stocking up the solid and the liquid and by the suitably arranged predetermined breaking point it can be ensured that a fresh solid-liquid mixture can be generated at any time.

In a further development it is of advantage for the solid to be dried milk and for the liquid to be water. This is particularly important for the preparation of baby food where milk prepared immediately before administration is desired for hygienic and nutritional reasons. So, together with the thermocouple provided according to the invention it is possible to prepare an optimally dosed, fresh prepared and heated baby milk. Nevertheless, further technical and non-technical applications are considered. In general, all possible dispersions and suspensions are suitable for this purpose.

Moreover, it is suitable for the thermocouple to be energetically self-sufficient. By energetically self-sufficient it is meant that no further measures have to be taken except the manual activation to put the thermocouple into operation. Especially it is meant that no external power supply or heat supply is required. Here, a decisive advantage is that the packaging enables to completely prepare the desired product at any place at any time. The basic idea is that no further steps or means are needed except of breaking the predetermined breaking point, mixing the substances, and putting into operation the thermocouple to obtain the desired state of the product. The thermocouple may be an element that can be used once or several times. Thermocouples that by means of chemical, electrical, and/or mechanical energy can generate a heat flow that is self-sufficient from external energy flows are conceivable, for example.

In a further development, the thermocouple is a heating element having a phase-change medium as well as an activation element. In this case, the phase-change medium is an exothermic phase-change medium. Typically, suitable phase-change media consist of a supercooled melt of a chemical compound or a mixture of substances. By an energy input, especially by the activation element, crystallization is induced in the phase-change medium whereby heat of crystallization is released. The temperature of the melt remains constant until complete crystallization. Here, the phase-change medium acts as a latent-heat storage tank that generates a defined amount of heat energy at a certain temperature and releases it into the environment via its wall. It is advantageous in this embodiment that the phase-change medium is present in a suitable concentration, amount, and nature in the packaging so that the mixture in the surrounding chambers can be brought to a defined temperature.

The activation element can be constructed mechanically or electrically. The activation element preferably is a leaf spring that snaps into an alternative position upon manual actuation and by this mechanical energy input induces crystallization in the melt. This can be achieved by simply pressing with a finger. Alternatively, the activation element can be electrically activated. The crucial thing is that the activation element supplies the melt with the activation energy needed to start crystallization or produces crystallization nuclei needed for that in the melt, respectively. The main advantage of said embodiment is that no further energies or means are needed except the manually/haptically supplied energy to achieve heating of the substances or mixtures that are present in surrounding chambers.

In an alternative embodiment the phase-change medium of the thermocouple is an endothermic phase-change medium. Accordingly, here on the other hand upon activation of the phase-change medium a heat flow from the environment into the phase-change medium is generated whereby the direct environment is cooled. According to the invention in this way cooling of the substances or mixtures present in the surrounding chambers is achieved.

Activation of the thermocouple preferably is independent of the generation of the mixture. Accordingly, both substances present separately from each other, but also the mixture generated can be heated or cooled after the predetermined breaking point has been broken.

As the phase-change media (PCM) salts (e.g. Glauber salt, sodium acetate) or organic compounds (e.g. paraffin waxes, fatty acids) can be used. These generally change their state of aggregation (liquid-solid) under energy input and thus, absorb heat energy and dissipate it.

In a further development, the thermocouple is of such a size that the mean temperature of the mixture generated is never above 37° C. In particular, this is of advantage in the preparation of foodstuff, especially in the preparation of baby food. Thus, by appropriate selection and quantity of the phase-change medium a baby food that on no account is too hot can be prepared in two easy steps. Accordingly, no further excipients for preparation and/or temperature control are needed.

Alternatively, it is conceivable for the thermocouple to be configured to generate a mean temperature above 37° C., especially above 60° C. For example, this is of advantage for the preparation of soups or teas, since in this way a pleasant and desired temperature is achieved. Moreover, higher temperatures are also needed in the generation of chemical products, for example adhesives or the like.

Further it is suitable for the thermocouple to be present loose or detachable in one of the chambers. This is of advantage in that in the preparation of the packaging production and development costs can be saved, since the thermocouple can easily be placed in the respective chamber next to the intended substance before sealing during the production method. It is also an advantage that such a thermocouple basically can be reused what saves costs and resources. Alternatively, it is also conceivable to form a chamber specifically provided for the thermocouple. In this case, it is of particular advantage for said chamber to have a predetermined breaking point to an adjacent chamber so that the mixture or a substance can come into contact with the thermocouple.

According to the invention it is of advantage for the packaging to have a hollow chamber for thermally insulating the packaging from the environment. The hollow chamber is preferably formed between the outer shell of the packaging and one or more chambers. The term hollow chamber relates to a chamber that is either filled with a gas with excess pressure or low pressure. Preferably, the gas is a gas of low heat conductivity, for example krypton or xenon. Especially preferred, a gas of low heat conductivity and low pressure is present in the hollow chamber. The advantage of a hollow chamber generally goes back to the reduced heat conduction between the chambers of the packaging and the environment.

In a further development it is of advantage for the packaging to further have a temperature indicator for indicating the temperature inside the packaging. Preferably, the temperature indicator comprises a temperature sensor that is connected to the inside of a chamber such that the temperature indicator indicates the internal temperature of the chamber. A temperature indicator enables to visually determine whenever the material or the mixture lying dose to the temperature indicator has reached a target temperature. At best, the temperature indicator provides a control panel that depicts a defined color after the target temperature has been reached. This may be accomplished for example by means of a conventional thermometer or by means of temperature-sensitive materials. This is of particular advantage when the chambers of the packaging are spaced apart from the outer shell of the packaging for example by a hollow chamber and therefore, their temperature cannot haptically be estimated.

In the following, the invention is explained in detail by way of examples shown in the drawings. Here:

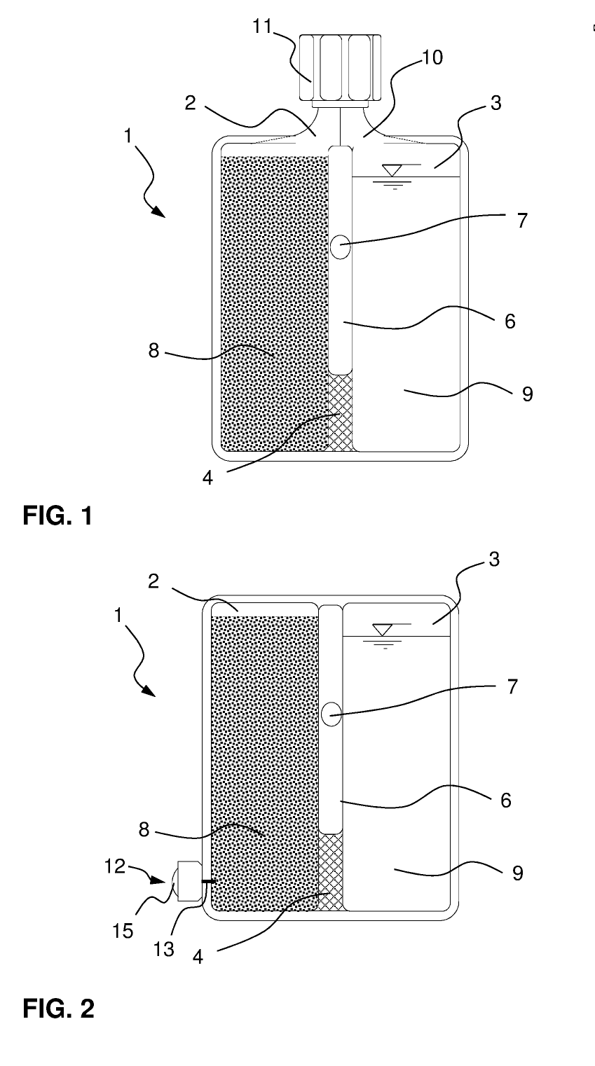

FIG. 1 schematically shows a packaging according to a first embodiment;

FIG. 2 schematically shows a packaging according to a second embodiment;

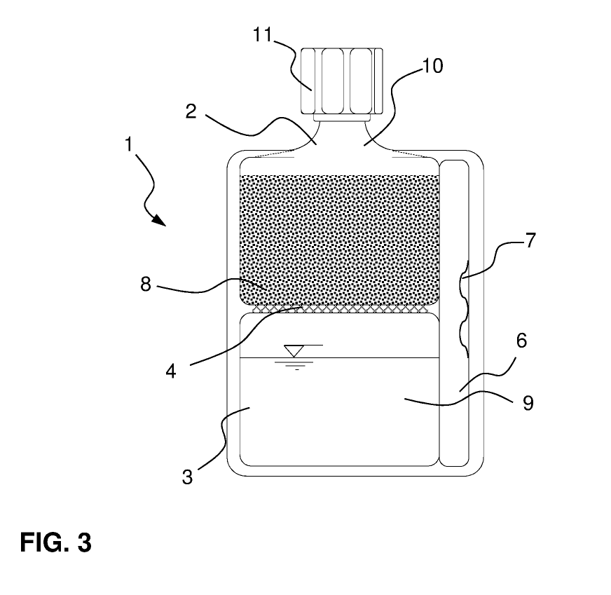

FIG. 3 schematically shows a packaging according to a third embodiment;

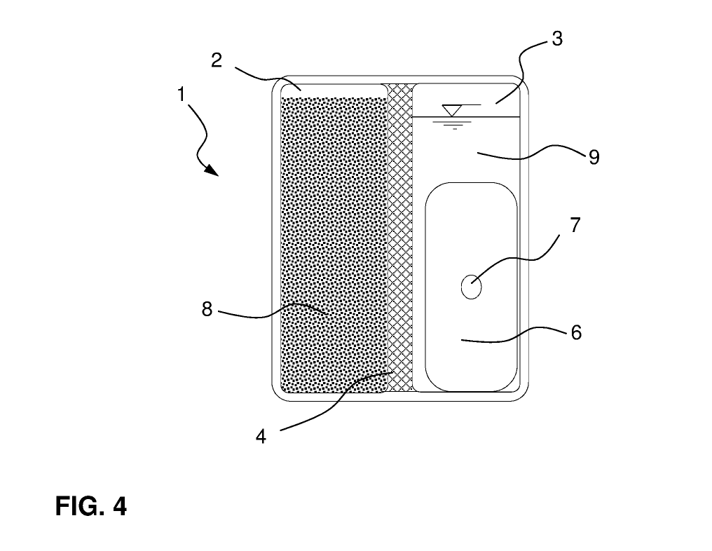

FIG. 4 schematically shows a packaging according to a fourth embodiment;

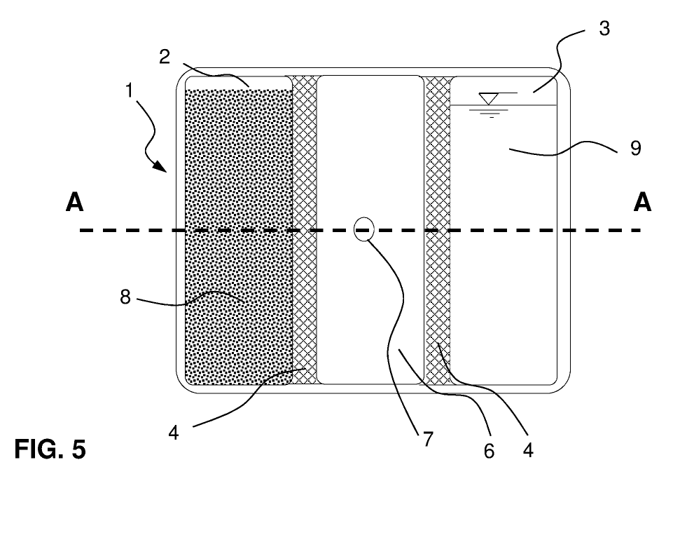

FIG. 5 schematically shows a packaging according to a fifth embodiment; and

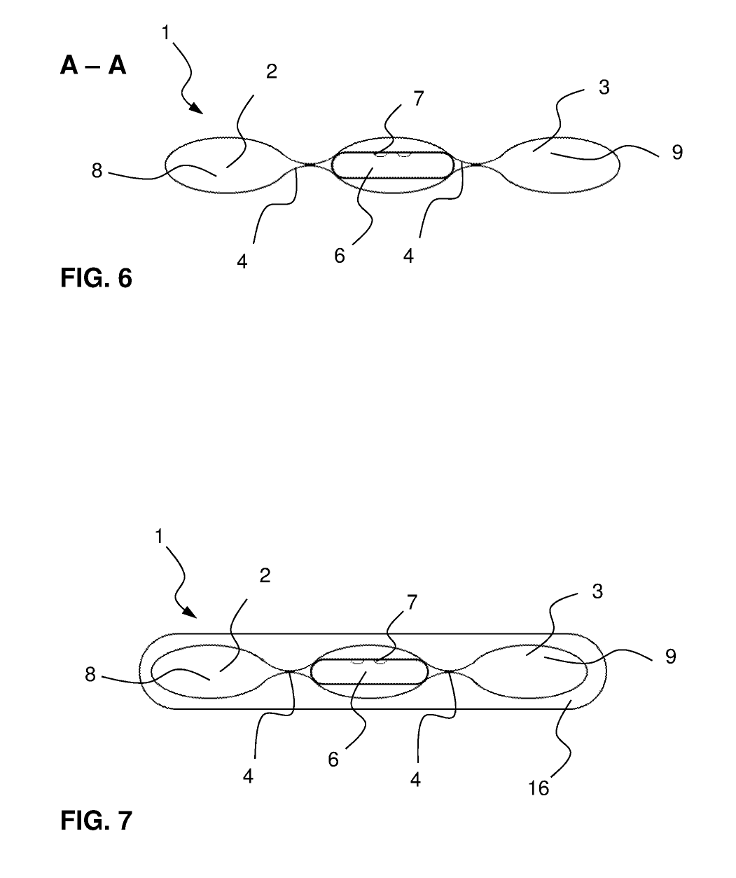

FIG. 6 schematically shows a packaging according to a fifth embodiment in a cross section A-A; and

FIG. 7 schematically shows a packaging according to a sixth embodiment.

FIG. 1 shows a packaging 1 according to the invention with a first chamber 2 and a second chamber 3 as well as a predetermined breaking point 4 that enables a fluid connection between the first chamber 2 and the second chamber 3 in the lower part of the packaging when this is broken by specifically applying force thereto. When breaking the predetermined breaking point 4 accordingly there is formed a new common chamber; mixing chamber 5 (not illustrated). Accordingly, now this consists of the first chamber 2 and the second chamber 3. Between the first chamber 2 and the second chamber 3 there are further a thermocouple 6 and an activation element 7. Here, the thermocouple 6 is to be an exothermic phase-change medium that crystallizes as a result of an activation by the activation element 7 and as a result releases heat to the first chamber 2 and the second chamber 3. In the case shown the activation element 7 is in the form of a leaf spring. It is further apparent from FIG. 1 that a solid 8 is present in the first chamber 2 and a liquid 9 is present in the second chamber 3. Both chambers separately lead to a common outlet 10 that is closed by screw cap 11.

For preparing the solid-liquid mixture now at first the predetermined breaking point 4 is broken and the solid 8 from the first chamber 2 is mixed with the liquid 9 from the second chamber 3. This way, a common chamber 5 is formed that contains a mixture, which can flow around or wet the thermocouple 6, respectively. Optionally, the mixture is shaken. The thermocouple 6 can be activated at any time during the preparation whereby heat is released. Generally, activation is after breakage of the predetermined breaking point 4 or at about the same time. Simultaneous shaking during heating results in an improved heating of the mixture due to better circumflow and turbulent heat transfer. As soon as the mixture has reached the desired mean temperature, the screw cap 11 is opened and the mixture is discharged from the packaging 1.

FIG. 2 corresponds to a somewhat simplified version of the embodiment illustrated in FIG. 1. Here, common outlet 10 and the screw cap 11 are not formed. For emptying the packaging 1 a periphery of the packaging is cut off or open and the mixture is taken out after the solid 8 has been mingled with the liquid 9. In order to visually determine the temperature there is further provided a temperature indicator 12 that by means of a temperature sensor 13 projecting into the first chamber depicts a visual signal that enables drawing conclusion about whether or not the desired temperature has been reached. In the example shown, the temperature sensor 13 is a fluid thermometer that is of such a size that when reaching a target temperature the expansion liquid colors an area on the display panel 14 of the temperature indicator. Of course, it is also possible to use a temperature indicator 12 with a non-contacting temperature sensor, for example with a temperature sensor that can be stuck on. This may be appropriate for reasons of hygiene.

FIG. 3 shows a somewhat modified embodiment of packaging 1. Here, the first chamber 2 and the second chamber 3 are arranged one above another and can be connected to each other to a common chamber 5 by a horizontally extending predetermined breaking point 4. Here, the thermocouple 6 is laterally arranged and extends over the overall height of both superimposed chambers. Preparation of the mixture is identical to the above-described procedure.

In FIG. 4 there is depicted a further simplified embodiment of the packaging 1 according to invention. Here, packaging 1 substantially consists of only one film that is sealed at its edges such that it is in the form of a pouch- or bag-like structure. Further, the packaging has a vertically extending predetermined breaking point 4 that extends along the overall height or length, respectively of the packaging 1. In this way, a first chamber 2 and a second chamber 3 are formed. The predetermined breaking point used for that is formed in that both film layers of the outer shell are detachably connected to each other at their inner sides. For detaching the predetermined breaking point, one of the chambers is pressurized whereby both detachably connected film layers again separate from each other and a common chamber 5 is formed. The packaging is heated or cooled by means of the thermocouple 6. Here, the thermocouple 6 is present in either chamber freely moveable or fixed on one side. The thermocouple is realized as a flat member in order to form a heat-conducting surface as large as possible. That is, to prepare the mixture, at first the predetermined breaking point 4 is detached, the thermocouple 6 is activated, and the mixture is heated during shaking. For taking out the mixture, the packaging is opened at any site. The thermocouple 6 can be reused.

Alternatively, the thermocouple 6 can also be housed in its own chamber, as illustrated for example in FIG. 5 and FIG. 6. Also here, the packaging 1 consists of two layers of a film that are sealed at their edges and detachably connected to each other along the predetermined breaking points 4. Due to the solid 8 being separated from the liquid 9 by two predetermined breaking points 4 undesired mixing by inadvertently detaching a predetermined breaking point 4 is minimized. In FIG. 6 this is made clear by a cross section along cut A-A. A further chamber is formed between the first chamber 2 and the second chamber 3 that encloses the thermocouple 6. Here, it is not necessary for the chamber to be larger than the thermocouple 6; the chosen illustration is only for graphic clarification. In order to obtain the desired preparation accordingly the two predetermined breaking points 4 have to be detached and the thermocouple 6 must be activated by means of the activation element 7. As soon as the predetermined breaking points 4 have been detached, the obtained mixture flows around the thermocouple at its heat-conducting surface. By providing a hollow chamber 16 heating efficiency can significantly be improved. Such a hollow chamber is schematically illustrated in FIG. 7, for example. By the presence of the hollow chamber heat transport between the chamber and the environment is always via the gas-filled cavity that surrounds the individual chambers of the packaging 1. Said transport is always less than the heat transport resulting from solid or liquid materials directly adjacent to the chamber, in particular when the gas in the hollow chamber 16 is gas of low heat conductivity, for example krypton or xenon.

### LIST OF REFERENCE SYMBOLS

1 packaging
2 first chamber
3 second chamber
4 predetermined breaking point
5 mixing chamber
6 thermocouple
7 activation means
8 solid
9 liquid
10 outlet opening
11 screw cap
12 temperature indicator
13 temperature sensor
15 display panel
16 hollow chamber

1. A packaging having a plurality of material-tight separated chambers, wherein the chambers contain different substances, and having at least one predetermined breaking point that is formed between two adjacent chambers such that a break in the predetermined breaking point enables a material exchange of the substances of chambers adjacent to the predetermined breaking point,
characterized in that
the packaging further has a thermocouple capable of being activated that causes an energy flow from or into at least one of the chambers in an activated state, wherein the chambers of the packaging are formed of a continuous film.

2. (canceled)

3. The packaging according to claim 1, characterized in that
the predetermined breaking point consists of two film layers that detachably adhere to each other.

4. The packaging according to claim 1,
characterized in that
the thermocouple provides a heat-conducting surface that contacts the generated mixture.

5. The packaging according to claim 1,
characterized in that
a first chamber of the packaging contains a solid and a second chamber of the packaging contains a liquid, wherein a predetermined breaking point is formed between the first chamber and the second chamber.

6. The packaging according to claim 4,
characterized in that
the solid is dried milk and the liquid is water.

7. The packaging according to claim 1,
characterized in that
the thermocouple is energetically self-sufficient.

8. The packaging according to claim 1,
characterized in that
the thermocouple is a heating element that has a phase-change medium as well as an activation element.

9. The packaging according to claim 7,
characterized in that
the activation element is a leaf spring that can be actuated manually.

10. The packaging according to claim 1,
characterized in that
the thermocouple is of such a size that the mean temperature of the mixture generated is never above 37° C.

11. The packaging according to claim 1,
characterized in that
the thermocouple is present loose in one of the chambers.

12. The packaging according to claim 1,
characterized in that
the packaging has a hollow chamber for thermally insulating the packaging from the environment.

13. The packaging according to claim 1,
characterized in that
the packaging has a temperature indicator for indicating the temperature inside the packaging.
